(19) United States
(12) Patent Application Publication
(10) Pub. No.: US 2012/0287535 A1
(43) Pub. Date: Nov. 15, 2012

(54) Wavy Lapping Tape for Repair of Negative Pressure Tape Head

(75) Inventor: George A. Saliba, Boulder, CO (US)

(73) Assignee: SALIBA INNOVATIONS, LLC, Boulder, CO (US)

(21) Appl. No.: 13/103,405

(22) Filed: May 9, 2011

(51) Int. Cl. G11B 5/78

(52) U.S. Cl. 360/132; 360/134; G9B/5.291

(57) ABSTRACT

Method and system for manufacturing wavy lapping tape and/or wavy cleaning tape for use in the manufacturing and/or repair of negative pressure tape head(s) contour. The wavy lapping tape may be designed with predetermined wave frequency and amplitude to maintain the required contact between the negative pressure head transducer and the lapping tape and/or cleaning tape to repair negative pressure tape head(s). When the wavy lapping tape is implemented within cartridges, the present invention enables automated head test and repair of negative pressure head(s) in drives within the tape library without the need to remove heads from the drives.

### BACKGROUND

Magnetic storage devices remain a viable solution for the storage and retrieval of large amounts of data. The use of magnetic tape cartridges, e.g., such as half-inch Linear Tape Open (“LTO”), Digital Linear Tape (“DLT”), and helical scan tapes formats, such as 4 mm (“DAT”, “8 mm”) are well known in the art. Tape cartridges can store vast amount of data. Tape drives, used either singly or in a tape library (also referred to as a media library), each include transducers or heads (such as thin film magneto-resistive (MR) head) that reads and/or writes data to the tape cartridges. For proper operation of the tape drive, the head must maintain very close proximity between the tape and the recording elements in order to provide the ability to record and reproduce signals. Tape drives operate in an open environment and heads can be exposed to various contaminants from the open air and/or from the storage tape itself. Today's heads require very low separation between the head and the storage tape for greater accuracy in reading and writing of data. Excessive separation between the head and the storage tape and/or sensor damage such as scratches, nicks or other abrasions to the head itself can result in reading and writing errors or even head failure.

It is well known that tape to head separation increases when contaminants build up on the surface of the head. Cleaning cartridges or brushes can be used to remove loose contaminants. Unfortunately, these types of cleaning devices can be relatively ineffective for removing hardened deposits on the head. Further, when the sensor of the head is impacted with sufficient force, or when a conductive material causes a short in an element in the head, the head is rendered unusable and the drive must be repaired. In addition, high contact pressure between heads and the tape abrasive materials can generate surface scratches that effectively create permanent separation between the tape and the head. Head sensor damage reduces the head signal and is one of the primary causes for frequent drive failures.

Presently, the drive repair process may be done at the factory where drives with defective heads are disassembled and heads are carefully removed. Failed heads are returned to head vendors for repair or rebuild.

Older tape drives, such as SDLT600 use low radius heads designed for high tape to head contact pressure operation. Tape drives with high pressure contact can be repaired without the need for head removal by applying commonly available lapping tape and/or cleaning tape technologies and lapping the heads according to U.S. Pat. No. 7,395,983 issued to George Saliba.

Modern tape drives use flat heads or large radius contours to reduce the tape pressure and increase head life. These heads are commonly known as negative pressure contours.

It is well known in the industry that traditional lapping or cleaning tape technologies are not effective in lapping or repairing negative pressure head contours due to the inability of the tape to maintain contact when the head radius is larger than the natural contour radius of the tape. Prior art lapping tape technology fails to maintain contact with the recording or reproducing elements located at the center of the negative pressure islands, thereby rendering the lapping tape or cleaning tape repairs ineffective.

Therefore there is a need for a lapping tape and cleaning tape that can effectively repair negative pressure heads.

### SUMMARY

The present invention is directed toward a wavy lapping tape able to repair drives utilizing heads with negative pressure contours. In one embodiment, the wavy lapping tape can be used to repair the head outside the drive. In another embodiment, the wavy lapping tape is included in a tape cartridge that includes a test tape and wavy lapping tape to repair the head in the drive. In another embodiment, the wavy lapping tape can include a diamond material having a grit of between approximately 0.1 micron and 1.0 micron. In another embodiment, the wavy lapping tape is formed with pins attached to the back of the tape with diameter between 5 micron and 500 microns whereas the tape spooling pressure on the pin deforms the standard lapping tape into a wavy lapping tape. In another embodiment, a second wavy lapping tape that has a different grit and wave than the first wavy lapping tape. In another embodiment, the tape includes a wavy cleaning tape with bumps between 5 microns and 500 microns to effectively clean the negative pressure head contours. The wavy cleaning tape can be spliced to one of the wavy lapping tapes or the data storage tape.

The present invention is directed toward a method for manufacturing of a wavy lapping tape and a wavy cleaning tape to repair low pressure head contour at the factory or in the drive.

The present invention is also directed toward a tape library that includes a tape drive and at least one of the tape cartridges with wavy lapping tape or wavy cleaning tape

The present invention is also directed toward a method for manufacturing of tape cartridges with wavy lapping tape and/or wavy cleaning tape.

### BRIEF DESCRIPTION OF THE DRAWINGS

The invention, together with further advantages thereof, may best be understood by reference to the following description taken in conjunction with the accompanying drawings, taken in conjunction with the accompanying description, in which similar reference characters refer to similar parts, and in which:

FIG. 1 is a block diagram of one embodiment of a media library having features of the present invention including a plurality of tape drives and a plurality of tape cartridges;

FIG. 2 is a top view of a portion of one embodiment of the tape drive and the tape cartridge;

FIG. 3 is a side view of prior art lapping tape;

FIG. 4 is a side view of a high pressure contour head using prior art lapping tape;

FIG. 5 is a side view of a negative pressure contour head contact profile when using prior art lapping tape in which the head radius is larger than the nature contour of the lapping tape;

FIG. 6 is a side view of a negative pressure contour flat head contact profile when using prior art lapping tape;

FIG. 7 is one embodiment of pre-formed wavy lapping tape base film with raised surface according to the invention;

FIG. 8 is another embodiment of pre-formed wavy lapping tape according to the invention;

FIG. 9 is one embodiment of the self forming wavy lapping tape using cured adhesive;

FIG. 10 is another embodiment of the self forming wavy lapping tape using bumps attached to the back side of the lapping tape;

FIG. 11 is another embodiment of the self forming wavy lapping tape using pins added to the back side;

FIG. 12 is a side view of a negative pressure contour flat head contact profile when using wavy lapping tape according to the invention;

FIG. 13 is a side view of a portion of one embodiment of the tape drive including a tape head and a controller, and a portion of the tape cartridge including the tape;

FIG. 14 is a side view of a portion of one embodiment of a wavy lapping tape of the tape cartridge;

FIG. 15 is a side view of a portion of another embodiment of the wavy lapping tape of the tape cartridge;

FIG. 16 is a side view of a portion of yet another embodiment of the wavy lapping tape of the tape cartridge;

FIG. 17 is a flow diagram illustrating one embodiment of a method for repairing the tape drive in accordance with the present invention; and

FIG. 18 is a flow diagram illustrating another embodiment of a method for repairing the tape drive in accordance with the present invention.

### DESCRIPTION

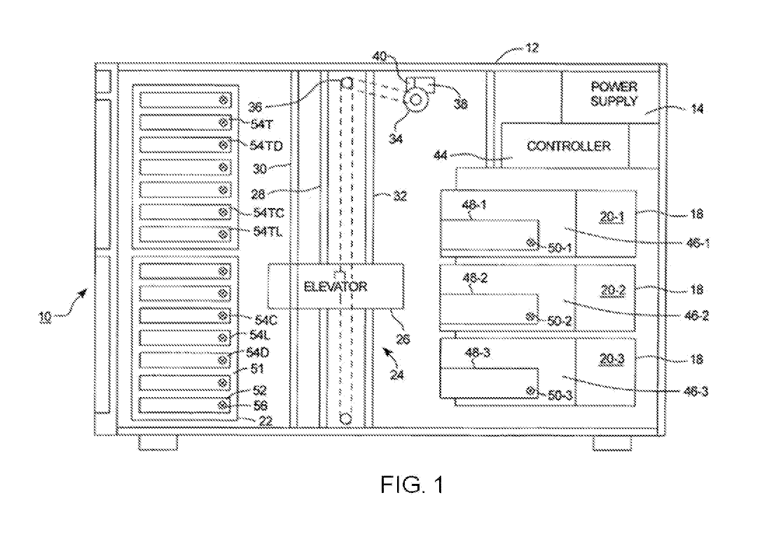

FIG. 1 is a simplified schematic view of one embodiment of a media library 10, in the form of a multi-drive, mass storage and retrieval tape library/loader unit. In one embodiment, the media library 10 includes a housing 12, a power supply 14, a plurality of drive assembly receivers 18, a plurality of tape drive assemblies 20-1, 20-2, 20-3 (also sometimes generically referred to herein as tape drive assemblies 20), one or more cartridge retainer receivers 22, a cartridge mover 24 including a cartridge pass-through and/or rotating elevator 26. It is recognized that many different suitable types of cartridge movers 24 can be utilized in the media library 10, and that the cartridge mover 24 provided herein is merely representative of one such type and is not intended to limit the scope of the present invention in any manner.

Each of the drive assembly receivers 18 receives one of the tape drive assemblies 20. As provided herein, each of the tape drive assemblies 20 can include a corresponding tape drive 46-1, 46-2, 46-3 (i.e. Quantum DLT S4™) , (i.e. HP LTO-5™) (i.e. IBM. LTO-2™, LTO-3™, LTO-4™, LTO-5™, TS1120™, TS1130™), (Oracle-STK T10000C™), (DAT 72™, DAT320™) or equivalent, as (non-exclusive examples).

The media library 10 can use well-known industry standard cabling and communication protocols between the controller 44 and other components of the media library 10. Cabling and electrical characteristics including signaling protocols can be generally standardized, and the logical message protocols can be either proprietary or standardized as known to those skilled in the art.

Additionally, as set forth in greater detail below, the controller 44 can determine whether a problem with one or more tape drives 46 may be occurring. For example, the controller 44 can monitor the reading and/or writing error rate of the tape drive 46 to determine if this error rate is above a predetermined threshold. If so, the controller 44 can take certain steps to mitigate or reduce the error rate, as described below. Alternatively, the controller 44 can monitor other performance parameters of a universal test cartridge preformatted to determine whether a performance problem may exist with one or more of the tape drives 46.

Various non-exclusive examples of performance parameters include the controller 44 monitoring an output of the tape drive 46, a resolution of a signal from the tape drive 46, an error rate in reading of data from test tape cartridge 54, an error rate in writing of data to the cartridge 54, and/or a signal-to-noise ratio (S/N ratio) of the tape drive 46. The controller 44 can determine whether these or other suitable parameters are above or below a predetermined threshold level for each parameter, at which point the controller 44 can selectively initiate corrective action in accordance one or more embodiments described herein. In certain embodiments, the controller can use an algorithm that is based on one or more of the above performance parameters to determine whether corrective action is required for the tape drive, as more fully described below. In an alternative embodiment, the tape drive's own drive circuitry can provide one or more of the above-referenced functions provided by the controller 44.

The types of cartridges 54 in the media library 10 can vary. For example, the cartridges 54 can include one or more data cartridges 54D, one or more wavy lapping cartridges 54L, and/or one or more combination cartridges 54C. The data cartridge 54D includes a magnetic storage tape that is adapted to store data. The wavy lapping cartridge 54L includes wavy lapping tape that is adapted to perform a wavy lapping operation on a portion of the tape drive 46. The combination cartridge 54C includes both the storage tape and the wavy lapping tape, as described in greater detail below.

Any number of each type of cartridge 54 can be present within the media library 10 to satisfy the design requirements of the media library 10. In certain embodiments, all three types of cartridges 54D, 54L, 54C are present. Alternatively, one or more of these types of cartridges 54D, 54L, 54C may be absent from the media library 10. Still alternatively, the media library can also include other types of cartridges, such as a wavy cleaning cartridge 54CL that includes a wavy cleaning tape for cleaning dust or other particulates from portions of the tape drive 46. In another embodiment, the wavy cleaning tape can also be included as part of the combination cartridge 54C.

In one embodiment, two of more different types of cartridges 54D, 54L, 54C generally have a substantially similar form factor. In another embodiment, the form factor for two or more of the cartridges 54D, 54L, 54C can be different.

FIG. 2 illustrates one embodiment of a cartridge 254 and the tape drive assembly 220, which includes one tape drive 246. It is recognized that the tape drive assembly 220 described herein can be part of the media library 10 as illustrated in FIG. 1, or the tape drive assembly 220 can be a stand-alone type of assembly.

In the embodiment illustrated in FIG. 2, the tape drive 246 includes a drive housing 258, a tape head 260, a take-up reel 262 having a drive leader 264 and a take-up reel hub 266, a cartridge receiver 268, a buckler 270 and the controller 244. In one embodiment, the cartridge 254 includes a cartridge housing 272, a cartridge reel 274 having a cartridge hub 276 (shown in phantom), a tape 278, and a cartridge leader 280 having a cartridge buckle component 282. The buckler 270 secures the drive leader 264 to the cartridge leader 280. The buckler 270 moves the drive leader 264 relative to the cartridge leader 280 to automatically buckle and/or unbuckle the drive leader 264 to the cartridge leader 280 in ways known to those skilled in the art. Further, the specific type of buckler 270 included in the tape drive assembly 220 can include any type of device that secures the drive leader 264 to the cartridge leader 280, and can be varied in ways known to those skilled in the art.

In one embodiment, the tape 278 of one of the cartridges 254 includes a storage tape only, which magnetically stores data in digital form. In another embodiment, the tape 278 of one of the cartridges 254 includes a wavy lapping tape only, which includes a relatively abrasive material such as 0.5 micron diamond tape that can inhibit severe induced shorts, and reduce or remove scratches and other imperfections, persistent deposits and other particulates or contaminants from the tape head 260. In still another embodiment, the tape 278 in one of the cartridges 254 can include a combination of at least two different types of tape, such as the storage tape and the wavy lapping tape, as one non-exclusive example. It is recognized that the combination of different tapes within a single cartridge 254 can also include other suitable types of tape that can vary depending upon the design requirements of the tape drive 246, such as a wavy cleaning tape as one non-exclusive example.

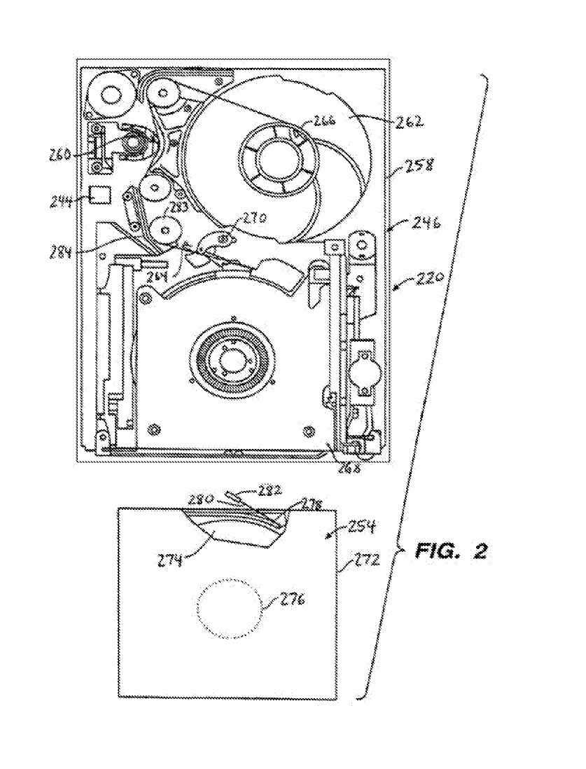

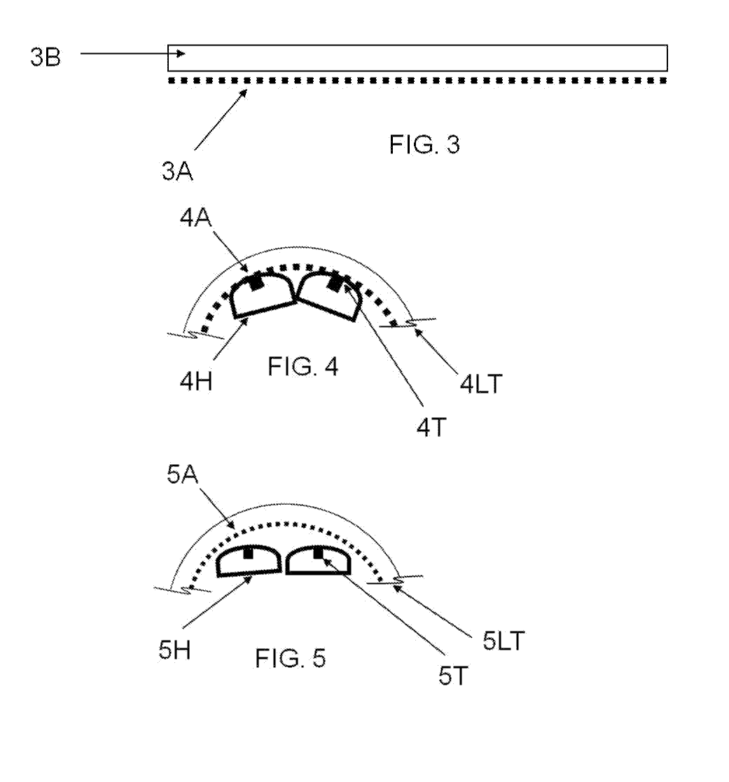

FIG. 3 is a prior art lapping tape currently used to repair drives with high pressure heads. The tape typically consists of a base film 3B made of suitable material such as PET, PEN or Poly-Aramid. The 3A side is coated with an abrasive material such as diamond, Al-Oxide or other materials capable of lapping the head.

FIG. 4 is a prior art high pressure contour head 4H using prior art lapping tape. The lapping tape 4LT maintains high pressure contact with the recording and/or reproducing elements 4T enabling the lapping tape to repair defective heads. The 4A side is coated with an abrasive material such as diamond, Al-Oxide or other materials capable of lapping the head. The radius of the head 4H is equal to or smaller than natural radius of the tape 4LT at the drive operating tension.

FIG. 5 is a side view of a large radius head 5H with negative pressure contour when using prior art lapping tape 5LT with a natural radius smaller than the head radius. The 5A side is coated with an abrasive material such as diamond, Al-Oxide or other materials capable of lapping the head. The abrasive material 5A does not contact the recording and/or reproducing element 5T with sufficient pressure therefore the prior arts lapping or cleaning tape cannot effectively repair defective large radius heads.

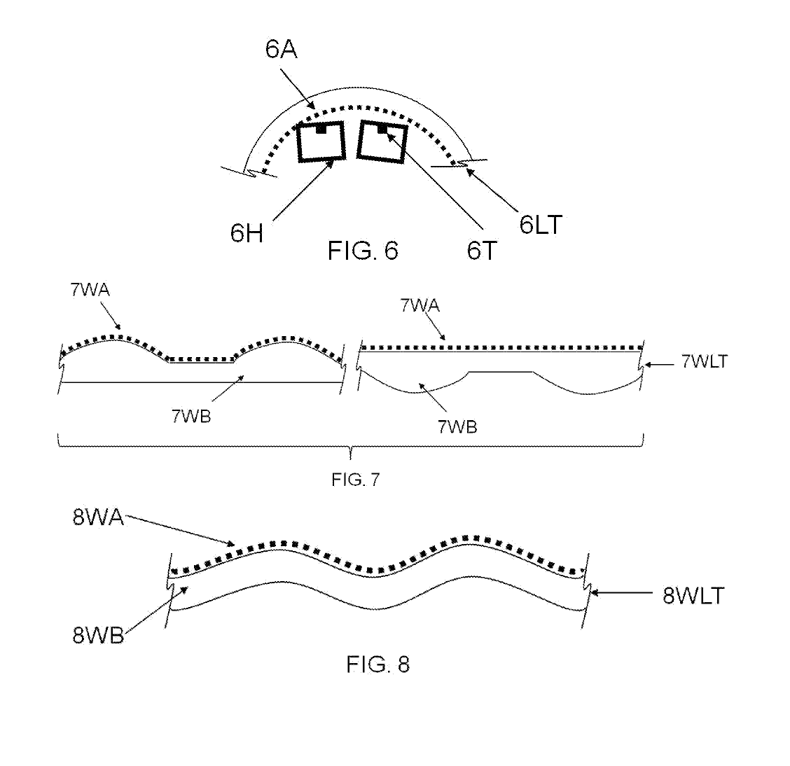

FIG. 6 is a side view of negative pressure flat head contour 6H when using prior art lapping tape 6LT with a natural radius smaller than the head radius. The 6A side is coated with an abrasive material such as diamond, Al-Oxide or other materials capable of lapping the head. The lapping tape abrasive side 6A does not maintain contact with the recording and/or reproducing element 6T. The prior art lapping or cleaning tape cannot effectively repair defective flat heads.

FIG. 7 is one embodiment of the preformed wavy lapping tape according to the invention. The lapping tape base film 7WB may be formed with bumps with predetermined amplitude and frequency to effectively contact the flat head on one or both surfaces. To form wavy lapping tape 7WLT, an abrasive material 7WA, such as diamond, Al-Oxide or other materials capable of lapping the head, may be applied to either the bump or flat side The preferred bump amplitude is between 10 and 200 microns and the distance between the bumps between 1 mm and 5 cm.

FIG. 8 is another embodiment of wavy lapping tape 8WLT that may be formed using a process to modify prior art lapping tape. The process consists of permanently deforming the prior art lapping tape base film 8WB and prior art abrasive material 8WA under pressure and high temperature and by using commonly available technologies. The preferred permanent deformation amplitude is between 10 and 500 microns and the preferred distance between the bumps may be between 1 mm and 5 cm.

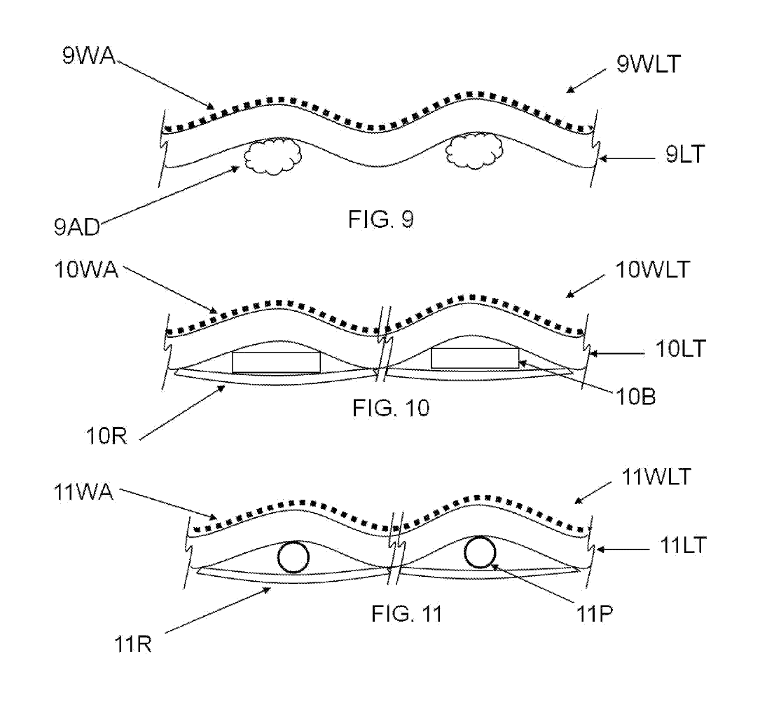

FIG. 9 is one embodiment of the self forming wavy lapping tape 9WLT using cured adhesive 9AD. The process consists of adding adhesive bumps to the non abrasive side of the prior arts lapping tape 9LT using fast curing adhesive 9AD on the opposite surface of the abrasive 9WA. The preferred bumps must maintain flexibility and adhesion over repeated lapping operation and the bump amplitude may be between 10 microns and 500 microns and the preferred distance between the bumps may be between 1 mm and 5 cm. The repeated winding of the lapping tape 9LT and the high winding pressure produces print through deformations on multiple wraps on the tape spool to create the wavy lapping tape.

FIG. 10 is another embodiment of the self forming wavy lapping tape 10WLT using bars 10B to the non abrasive side of the prior arts lapping tape 1OLT on the opposite surface of the abrasive 10WA. The process consists of adding bars 10B to the non abrasive side of the prior arts lapping tape. The bars 10B may be formed using a flexible polymer such as a plastic and may be retained using adhesive tape retainer 10R such as splicing tape. The preferred bars 10B must maintain flexibility and adhesion over repeated lapping operation and the bars 10B height may be between 50 microns and 500 microns and the bar 10B width may be between 50 microns and 500 microns and the preferred distance between the bars 10B may be between 1 mm and 5 cm. The repeated winding of the lapping tape 10LT and the high winding pressure produces print through deformations on multiple wraps on the tape spool to create the wavy lapping tape.

FIG. 11 is another embodiment of the self forming wavy lapping tape 11WLT using pins 11P to the non abrasive side of the prior arts lapping tape 11LT on the opposite surface of the abrasive 11WA. The process consists of adding pins 11P to the non abrasive side of the prior arts lapping tape. The pins 11P are retained by adhesive tape retainer 11R such as splicing tape. The preferred pins 11P material is plastic and the preferred pin 11P diameter may be between 10 microns and 200 microns and the preferred distance between pins may be between 1 mm and 5 cm. The repeated winding of the lapping tape 11LT and the high winding pressure produces print through deformations on multiple wraps on the tape spool to create the wavy lapping tape.

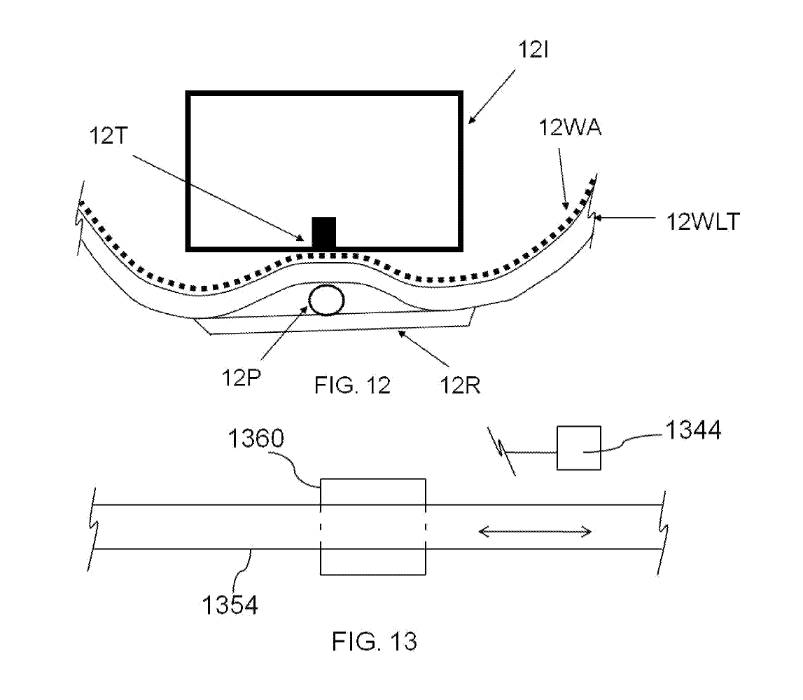

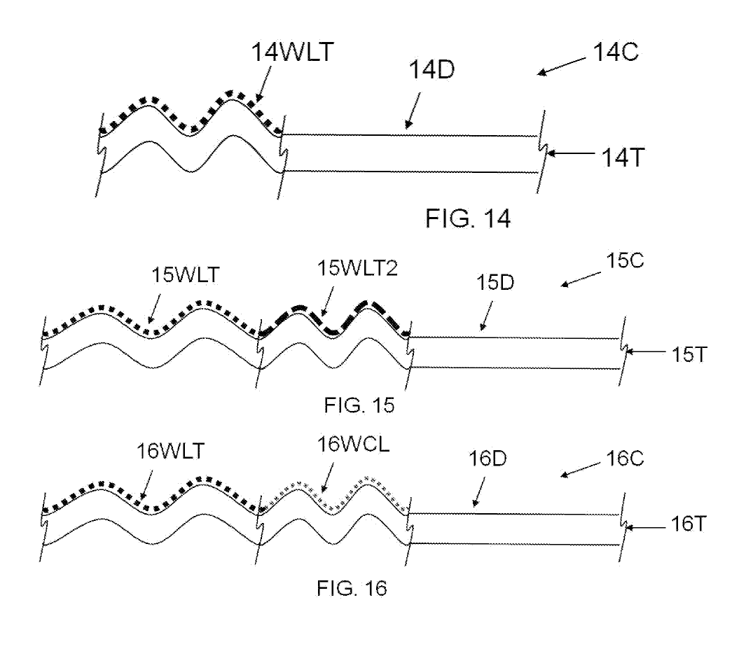

FIG. 12 is side view of the negative pressure contour flat head 121 when lapped using wavy lapping tape 12WLT according to the invention. As the wavy tape 12WLT moves over the head 121, the high side of the wave moves into close contact with the transducer 12T that contains the recording and/or reproducing elements. The repeated wavy contact between the lapping tape abrasive surface 12WA and the transducer 12T repair defective low pressure tape heads by removing contaminant and polishing transducer abrasions and/or other surface defects.

The wavy lapping tape 12WLT may be used to repair defective heads at the factory to improve yield and reduce the head manufacturing and repair process.

The wavy lapping tape technology maintains contact between the negative pressure head and tape enabling a lapping tape or cleaning tape to effectively repair the negative pressure heads. When implemented within cartridges, the present invention may enable automated head repair without the need to remove heads from the drives.

During normal library operation and if the controller 1344 (illustrated in FIG. 13) detects a problem with the tape drive 46-1, the controller 1344 can initiate a wavy lapping operation during which the wavy lapping tape 1354 is moved across the tape head 1360 in an attempt to resolve the problem. Following the wavy lapping operation, the tape head 1360 can be tested by performing a read, write, and/or test with preformatted data operation relative to the tape 1354, without the need for removing the cartridge that is in the tape drive 46-1. In an alternative embodiment, the data tape 14D can be used for testing the tape drive 46-1.

The proportion of the total length of the tape 14T that is storage tape 14D versus wavy lapping tape 14WLT can vary depending upon the design requirements of the tape drive assembly 20 and/or the media library 10. In one embodiment, the tape 14T can be substantially equally divided between storage tape 14D and wavy lapping tape 14WLT. Alternatively, the ratio of storage tape 14D to wavy lapping tape 14WLT can be at least approximately 0.01, 0.1, 0.5, 0.75, 0.9, 1.1, 1.25, 1.5, 2.0, 5.0, 10.0 or 100.0. Still alternatively, the ratio can be above or below the foregoing range.

The specific design of the wavy-data lapping tape 14T can vary to suit the design requirements of the tape drive assembly 20 and/or the media library 10. In one embodiment, the wavy lapping tape 14WLT can include an abrasive material such as a 0.1 micron diamond material with 100 microns pin diameter and pin separation of 2 cm. In non-exclusive alternative embodiments, the wavy lapping tape 14WLT can include a 0.5 micron or a 1.0 micron diamond material with 100 microns pin diameter and pin separation of 2 cm. Still alternatively, the size of the diamond material can be larger or smaller than these examples and pin diameter and distance can be larger or smaller. Further, the abrasive material can be formed from another suitable element or compound, provided the requisite level of wavy lapping of the tape head 1360 can be achieved.

The length of the wavy-data lapping tape 14T can likewise be varied. In one embodiment, the length of the wavy-data lapping tape 14T can be approximately 20 feet. Alternatively, the length can be less than or greater than this length.

The storage tape 14D and the wavy-data lapping tape 14T can be spliced together in a similar manner that other types of magnetic recording tapes are spliced together, i.e. in a manner known to those skilled in the art. Further, the storage tape 14D and/or the wavy lapping tape 14WLT can each be uninterruptedly positioned within the cartridge 14C, or the storage tape 14D and/or the wavy lapping tape 14WLT can alternate, e.g., be intermittently or alternate section with pins positioned within the cartridge 14C.

The tension of the wavy lapping tape 14WLT can be controlled by the controller 1344 using an algorithm for adjusting the tension of the tape 14T, which can be based on one or more of the pliability of the tape 14T, the curvature or other geometry of the tape head 1360 (illustrated in FIG. 13), and/or the grit of the wavy lapping tape 14WLT, as non-exclusive examples.

FIG. 15 is a side view of a portion of another embodiment of the tape 15T of a combination cartridge 15C. In this embodiment, the tape 15T includes a magnetic storage tape 15D for storing data, a first wavy lapping tape 15WLT and a second wavy lapping tape 15WLT2. In one embodiment, the first wavy lapping tape 15WLT can be substantially similar to the wavy lapping tape previously described herein. The second wavy lapping tape 15WLT2 may have a different grit and may have a different wave frequency than the first wavy lapping tape 15WLT. For example, the second wavy lapping tape 15WLT2 can be more or less abrasive than the first wavy lapping tape 15WLT. In addition, or in the alternative, the second wavy lapping tape 15WLT2 can include a different type of material, i.e. a different element or compound for wavy lapping of the tape head 1360 than the first wavy lapping tape 15WLT.

In the embodiment illustrated in FIG. 15, the first wavy lapping tape 15WLT and the second wavy lapping tape 15WLT2 are positioned adjacent to one another. In an alternative embodiment, the first wavy lapping tape 15WLT and the second wavy lapping tape 15WLT2 are separated by the storage tape 15D, or by another type of tape.

FIG. 16 is a side view of a portion of another embodiment of the tape 16T of a combination cartridge 16C. In this embodiment, the tape 16T includes a magnetic storage tape 16D for storing data, a wavy lapping tape 16WLT and a wavy cleaning tape 16WCL that is positioned between the storage tape 16D and the wavy lapping tape 16WLT. Alternatively, the relative positions of the tapes 16D, 16WCL, 16WLT can be different than that illustrated in FIG. 16. The wavy cleaning tape 16WCL can be a relatively non-abrasive type of tape known to those skilled in the art, which can remove dust and or other loose particulates that can be present on the tape head 1360 (illustrated in FIG. 13).

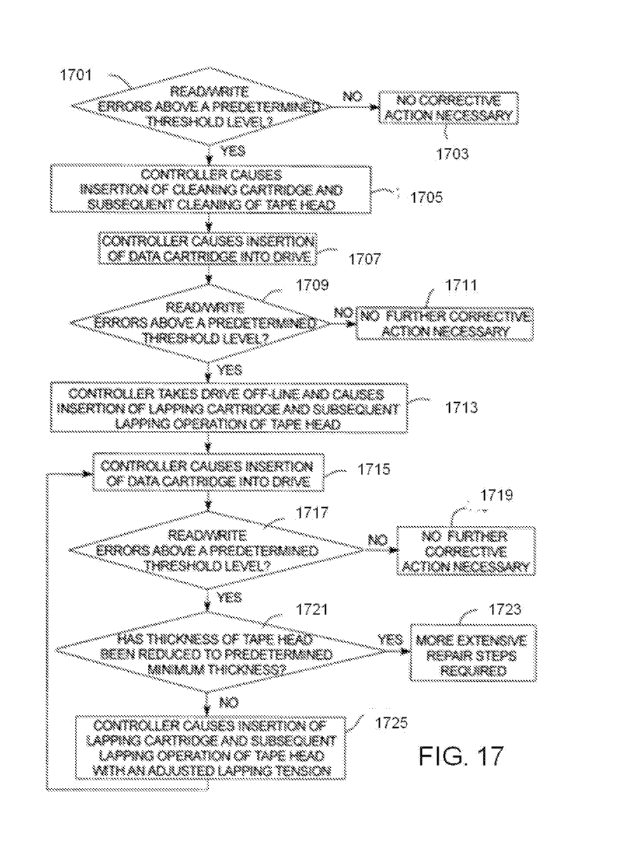

FIG. 17 is a flow diagram illustrating one embodiment of a method for repairing the tape drive in accordance with the present invention. In this embodiment, during normal operation of the tape drive, the controller determines whether read/write errors above a predetermined threshold level are occurring on a standard data cartridge (step 1701).

It is recognized that although FIG. 17 refers to “read/write errors”, this can be mean either read errors or write errors, or a combination of read and write errors. In addition or in the alternative, the controller can equally monitor other types of errors or performance characteristics of the tape drive to determine whether a predetermined threshold has been surpassed (either too high or too low). No limitations on the types of errors or performance characteristics of the tape drive that can be monitored by the controller are intended by simply referring to “read/write errors” in FIG. 17. Further, the predetermined threshold can be included as part of the firmware or drive circuitry of the tape drive and/or media library, or it can be manually input by an operator as required.

If the predetermined threshold is not exceeded, no corrective action is required (step 1703). If the predetermined threshold of read/write errors is exceeded, the controller can initiate insertion of a cleaning cartridge into the tape drive, and subsequent cleaning of the tape head (step 1705).

Once cleaning of the tape head has concluded, the controller can initiate reinsertion of the data cartridge (step 1707). The controller then monitors the read/write errors to determine if they are still above the predetermined threshold (step 1709). If not, no further corrective action is necessary (step 1711). However, if the read/write errors are determined by the controller to exceed the predetermined threshold, the controller can take the tape drive off-line (such as in a media library setting) and can initiate insertion of a wavy lapping cartridge and a subsequent wavy lapping operation of the tape head (step 1713).

Once the wavy lapping operation has concluded, the controller can initiate reinsertion of the data cartridge into the tape drive (step 1715). The controller can then monitor read/write errors to determine whether they exceed the predetermined threshold level (step 1717). If not, no further corrective action is necessary (step 1719). However, if the read/write errors exceed the predetermined threshold level, the controller can determine based on changes of various parameters such as amplitude, resolution, signal-to-noise ration, etc., whether the tension of the wavy lapping tape used in the most recent wavy lapping operation must be increased or reduced in order to achieve improved or optimum contact between the tape head and the storage tape (step 1721). Alternatively, the controller may determine that no adjustment of the tension is required. The predetermined optimum contact between the wavy lapping tape and the tape head can be achieved by following one of the known cursive methods of adjustment and can be preset by the operator or it can be programmed into the firmware of the tape drive.

The wavy lapping process reduces the thickness of the sensor of the tape head by removing material from the sensing element. If the most recent wavy lapping operation caused the sensor to reach a predetermined minimum thickness by monitoring the maximum allowable resistance or out of range bias current level, the tape drive must be serviced more extensively than by the present invention (step 1723), such as by the manufacturer or another service technician, i.e. replacing the tape head at the factory. In one embodiment, the controller can alert the manufacturer, service technician or another designated person to initiate the repair process. Further, the wavy lapping service life is reduced with repeated usage of the wavy lapping tape. If the predetermined maximum lifespan of the wavy lapping tape is reached during the most recent wavy lapping operation as determined by lack of wavy lapping effectiveness of removing material as measured by the parameters, the controller can insert a new wavy lapping cartridge and repeat the wavy lapping operation. The normal steps of repair include modifying the tension of the wavy lapping tape in incremental increasing or reducing steps until the tape head performance is restored to an acceptable level (step 1725) as required by the design requirements of the tape drive, the tape drive assembly or the media library.

Following the wavy lapping operation at the required and/or optimum tension, the controller initiates reinsertion of the data cartridge (step 1715), and the process repeats until the read/write errors no longer exceed the predetermined threshold level (steps 1717 and 1719), or until the tape head thickness has reached the predetermined minimum (steps 1721 and 1723).

It is recognized that although FIG. 17 describes the “predetermined maximum” relative to wavy lapping tension, this predetermined maximum can equally refer to frequency of oscillation of the tape head, lateral velocity of the wavy lapping tape across the tape head, or any combination of wavy lapping tension, frequency of oscillation of the tape head and/or lateral velocity of the wavy lapping tape across the tape head.

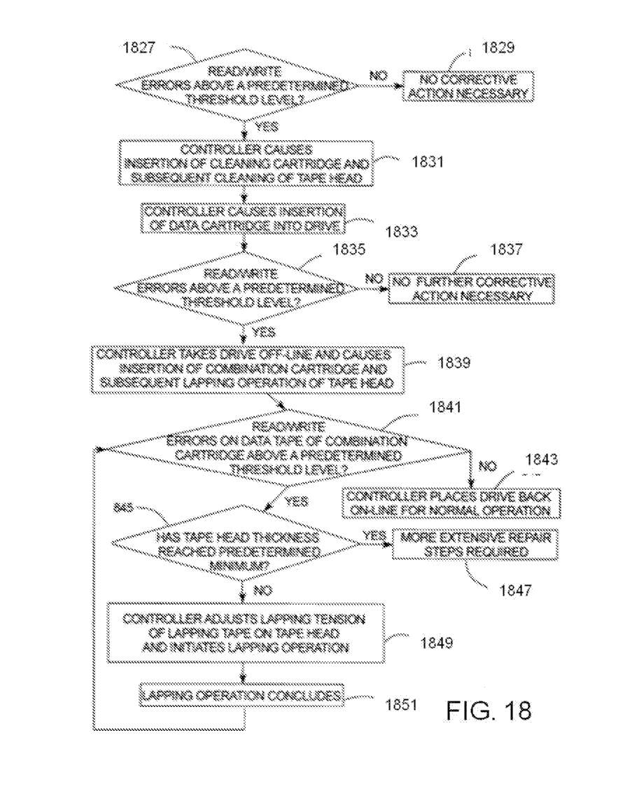

FIG. 18 is a flow diagram illustrating another embodiment of a method for repairing the tape drive in accordance with the present invention. In this embodiment, during normal operation of the tape drive, the controller determines whether read/write errors above a predetermined threshold level are occurring on a standard data cartridge (step 1827).

It is recognized that although FIG. 18 refers to “read/write errors”, this can be mean either read errors or write errors, or a combination of read and write errors. In addition or in the alternative, the controller can equally monitor other types of errors or performance characteristics of the tape drive to determine whether a predetermined threshold has been surpassed (either too high or too low). No limitations on the types of errors or performance characteristics of the tape drive that can be monitored by the controller are intended by simply referring to “read/write errors” in FIG. 18.

If the predetermined threshold is not exceeded, no corrective action is required (step 1829). If the predetermined threshold of read/write errors is exceeded, the controller can initiate insertion of a cleaning cartridge into the tape drive, and subsequent cleaning of the tape head (step 1831).

Once cleaning of the tape head has concluded, the controller can initiate reinsertion of the data cartridge (step 1833). The controller then monitors the read/write errors to determine if they are still above the predetermined threshold (step 1835). If not, no further corrective action is necessary (step 1837). However, if the read/write errors are determined by the controller to exceed the predetermined threshold, the controller can take the tape drive off-line (such as in a media library setting) and can initiate insertion of a combination storage tape and wavy lapping tape cartridge and a subsequent wavy lapping operation of the tape head (step 1839).

Once the wavy lapping operation has concluded, the controller can then monitor read/write errors relative to the storage tape of the same cartridge to determine whether they exceed the predetermined threshold level (step 1841). If not, no further corrective action is necessary and the controller can place the tape drive back on-line for normal operation (step 1843). However, if the read/write errors exceed the predetermined threshold level, the controller can determine whether the tension of the wavy lapping tape used in the most recent wavy lapping operation was higher or lower than the optimum level (or some other acceptable level) by comparing the most recent wavy lapping test results (step 1845), and whether the tension of the wavy lapping tape should be adjusted.

If the MR resistance or bias current of the wavy lapping tape in the most recent wavy lapping operation has reached a predetermined maximum level, the tape drive must be serviced more extensively than by the present invention (step 1847), such as by the manufacturer or another service technician. In one embodiment, the controller can alert the manufacturer, service technician or another designated person to initiate the repair process. If the predetermined MR resistance or bias current of the tape head had not yet been reached during the most recent wavy lapping operation, e.g., the thickness of the sensor of the tape head is not at or below a predetermined minimum thickness, the controller can repeat the wavy lapping operation with an adjusted tension of the wavy lapping tape (step 1849), i.e. higher or lower tension, as described previously. Alternatively, it may be determined that the tension does not need to be adjusted. In this embodiment, the wavy lapping operation can be performed again at substantially the same tension but for a longer duration, as one non-exclusive example.

Upon conclusion of the wavy lapping operation (step 1851), the controller can monitor read/write errors relative to the storage tape of the same cartridge to determine whether they exceed the predetermined threshold level (step 1841). This process repeats until the read/write errors no longer exceed the predetermined threshold level (steps 1841 and 1843), or until the tape head thickness has reached the predetermined minimum (steps 1845 and 1847).

Similar to the description of FIG. 17 above, it is recognized that although FIG. 18 describes the “predetermined maximum” MR resistance or bias current, this predetermined maximum can equally refer to frequency of oscillation of the tape head, lateral velocity of the wavy lapping tape across the tape head, or any combination of wavy lapping tension, frequency of oscillation of the tape head and/or lateral velocity of the wavy lapping tape across the tape head or the number of wavy lapping operations a particular tape head has undergone.

Furthermore, this remote repair operation can be applied to determine the need and apply remote corrective non-intrusive traditional drive repair such as updating the micro code of the tape drive and any other suitable tape drive settings prior to restoring the tape drive to an on-line status.

The wavy tape may be used to repair drive(s) in the factory or at the customer site. The low pressure contour head may be repaired inside or outside the drive using specialized equipment. While the particular tape cartridge 54 as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What claimed is:

1. A tape cartridge for use in a tape drive having a tape head, the tape cartridge comprising:
a cartridge housing;
a cartridge reel that is rotatably secured to the cartridge housing; and
a tape that is secured to the cartridge reel, the tape including a storage tape to which data is transmitted from the tape drive and a wavy lapping tape that selectively laps the tape head.

2. A tape cartridge for use in a tape drive having a tape head, the tape cartridge comprising:
a cartridge housing;
a cartridge reel that is rotatably secured to the cartridge housing; and
a tape that is secured to the cartridge reel, the tape including a storage tape to which data is written from the tape drive, the storage tape being selectively used for testing the performance of the tape heads and a wavy lapping tape is formed by pins attached to the non abrasive side of the wavy lapping tape that selectively laps the tape head.

3. A wavy lapping tape comprising:
raised surface features with predetermined shape;
raised surface features with predetermined frequency;
raised surface features with predetermined amplitude; and
to contact the center of a tape support bar of a negative pressure tape head contour
